(19) United States
(12) Patent Application Publication
(10) Pub. No.: US 2018/0096117 A1
(43) Pub. Date: Apr. 5, 2018

(54) INFORMATION PROCESSING APPARATUS, INFORMATION PROCESSING SYSTEM, AND USER AUTHENTICATION METHOD

(71) Applicant: FUJITSU LIMITED, Kawasaki-shi (JP)

(72) Inventors: Kosaku KIMURA, Kawasaki (JP); Yusuke Sasaki, Kawasaki (JP); Atsuji SEKIGUCHI, Kawasaki (JP); Shridhar CHOUDHARY, Kawasaki (JP); Tadahiro Uehara, Yokohama (JP)

(73) Assignee: FUJITSU LIMITED, Kawasaki-shi (JP)

(21) Appl. No.: 15/699,360

(22) Filed: Sep. 8, 2017

(30) Foreign Application Priority Data
Oct. 3, 2016 (JP) 2016-195382

(51) Int. Cl. G06F 21/31

(52) U.S. Cl. CPC G06F 21/31

(57) ABSTRACT

An information processing apparatus includes a storage unit and a processing unit. The storage unit stores therein first authentication information corresponding to an account of a user on a server, and a session ID generated by the server when the user logs in. Upon receipt of a processing request including second authentication information from a user apparatus operated by the user, the processing unit checks the second authentication information against the first authentication information. If the second authentication information and the first authentication information match, the processing unit includes the session ID in an acquisition request for data to be used in processing that is performed in accordance with the processing request, and sends the acquisition request to the server.

### CROSS-REFERENCE TO RELATED APPLICATION

This application is based upon and claims the benefit of priority of the prior Japanese Patent Application No. 2016-195382, filed on Oct. 3, 2016, the entire contents of which are incorporated herein by reference.

### FIELD

The embodiments discussed herein relate to an information processing apparatus, an information processing system, and a user authentication method.

### BACKGROUND

To launch a service to provide data and functions using a server, the administrator of the server prepares an Application Programming Interface (API) to call the service. The API defines procedures and data structures to enable computers running application software to use the service provided by the server. The API is built by the provider of the data or the developer of the functions, and is made available to users who use the service. For example, as an API, a web API that is accessible via a HyperText Transfer Protocol (HTTP) method is distributed.

In the case of using a web API, an API server is interposed, thereby improving the user-friendliness of an existing web service provided by a web server. The API server transforms data provided by the web server according to a web API-based processing request from a computer operated by a user, and sends the resultant data to the computer.

The user-operated computer executes application software (hereinafter, referred to as API use application) that uses a web API, for example, and sends a processing request to the API server using the web API during execution of the API use application. By doing so, for example, the user-operated computer is able to obtain data provided by the web server in prescribed data structure, and to perform various processing using the obtained data.

To allow the user to use the service provided by the web server, the web server may perform user authentication. Forms authentication is a user authentication method that is mainly used by web servers. In the forms authentication, the web server obtains user authentication information via a unique login screen using a HyperText Markup Language (HTML) form, and performs the user authentication. If the user authentication is successful and the login is complete, the web server sends a session identifier (ID) to the user-operated computer. After that, the web server identifies requests from the logged-in user using the session ID.

When a user uses a web service provided by a web server via an API server, the user accesses the web server via the API server and requests the web server to perform user authentication. As user authentication techniques via another server in this way, Single Sign-On and other various techniques are used. For example, there is a computer system that implements a Single Sign-On environment without modifying a backend server. In addition, there is considered a session authority management method that enables transfer of sessions with a website to another computer, without an additional authentication mechanism. There is also considered an authentication system that enables users to easily get authentication from a web server that needs the authentication. Further, there is also an authentication system that achieves authentication by delegating a Single Sign-On process for using a plurality of computer resources to a third party, without providing login IDs that are used within a corporate. Still further, a user may need to do authentication for each application that uses additional cloud services, which causes a complexity in operation. Therefore, there is considered a device apparatus to resolve such a complexity.

Please see, for example, Japanese Laid-open Patent Publication Nos. 2005-321970, 2008-226015, 2010-238060, 2012-203781, and 2014-67379.

To use a service provided by a server employing forms authentication, a user-operated computer logs in on a forms authentication login screen unique to the server, and manages a session ID issued by the server in corporation with the server. Therefore, in order that the user-operated computer uses the service of the server employing the forms authentication during execution of software such as an API use application, it is a prerequisite that the software complies with the specifications of the forms authentication of the server. For this reason, there is only limited software that is able to use the service provided by the server employing the forms authentication, and thus the service is not user friendly.

### SUMMARY

According to one aspect, there is provided an information processing apparatus including: a memory configured to store therein first authentication information corresponding to an account of a user on a server, and a session identifier (ID) generated by the server when the user logs in with the account; and a processor configured to perform a process including checking, upon receipt of a processing request including second authentication information from a user apparatus operated by the user, the second authentication information against the first authentication information, and including, when the second authentication information and the first authentication information match, the session ID in an acquisition request for data to be used in processing that is performed in accordance with the processing request, and sending the acquisition request to the server.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of a system according to a first embodiment;

FIG. 2 illustrates an example of a configuration of a system according to a second embodiment;

FIG. 3 illustrates an example of a hardware configuration of an API server that is used in the embodiment;

FIG. 4 is a block diagram illustrating functions of each apparatus;

FIG. 5 illustrates an example of an Application Programming Interface (API) management table;

FIG. 6 illustrates an example of an authentication information management table;

FIG. 7 illustrates an example of a cookie management table;

FIG. 8 illustrates an outline of an authentication process that is performed by an API server;

FIG. 9 is a flowchart illustrating a login screen request transmission process;

FIG. 10 is a flowchart illustrating an authentication information and cookie addition process;

FIG. 11 is a flowchart illustrating a user authentication and cookie acquisition process;

FIG. 12 is a flowchart illustrating an expired-cookie monitoring and update process;

FIG. 13 is a sequence diagram illustrating how to provide a service for a user;

FIG. 14 illustrates an example of a user registration request;

FIG. 15 illustrates an example of a login screen request;

FIG. 16 illustrates an example of login screen data that is sent from a web server;

FIG. 17 illustrates an example of login screen data that is sent from an API server;

FIG. 18 illustrates an example of a forms authentication request that is sent from an API use apparatus;

FIG. 19 illustrates an example of a forms authentication request that is sent from the API server;

FIG. 20 illustrates an example of post-login screen data;

FIG. 21 illustrates an example of a registration completion message;

FIG. 22 illustrates an example of a resource request based on Basic authentication;

FIG. 23 illustrates an example of a screen request;

FIG. 24 illustrates an example of screen data; and

FIG. 25 illustrates an example of resource data.

### DESCRIPTION OF EMBODIMENTS

Several embodiments will be described below with reference to the accompanying drawings, wherein like reference numerals refer to like elements throughout. It is noted that the features of the embodiments may be combined unless they exclude each other.

### First Embodiment

The following describes a first embodiment.

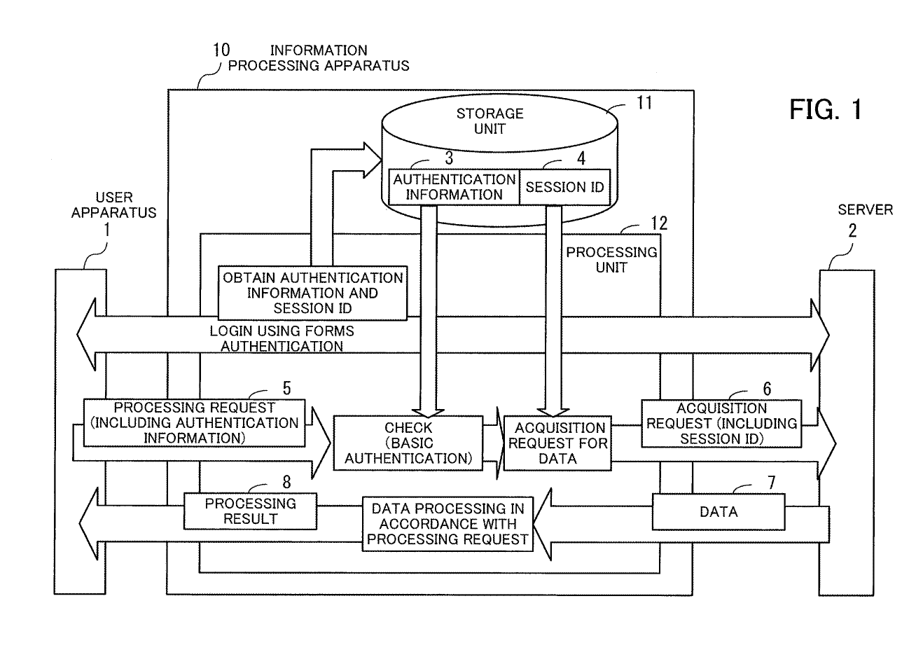

FIG. 1 illustrates an example of a configuration of a system according to a first embodiment. An information processing apparatus 10 is provided between a user apparatus 1 and a server 2. The user apparatus 1 is a computer that is operated by a user who uses a service provided by the server 2. The server 2 is a computer that provides the service. The information processing apparatus 10 is a computer that performs prescribed processing on data provided by the server 2, and sends the processing result to the user apparatus 1. For example, the information processing apparatus 10 is an Application Programming Interface (API) server.

The information processing apparatus 10 includes a storage unit 11 and a processing unit 12. For example, the storage unit 11 is a memory or a storage device that is provided in the information processing apparatus 10, and the processing unit 12 is a processor that is provided in the information processing apparatus 10.

The storage unit 11 stores therein authentication information 3 corresponding to an account of a user on the server 2, and a session identifier (ID) 4 that is generated when the user logs in to the server 2 with the account.

Upon receipt of a login request including the authentication information 3 from the user apparatus 1, the processing unit 12 sends the login request directed to a prescribed resource of the server 2. For example, the prescribed resource is a resource (a program module or the like) that corresponds to a function of performing forms authentication in the server 2. After the server 2 performs the user authentication in response to the login request and the login is successful, the server 2 sends the session ID 4 to the information processing apparatus 10. Upon receipt of the session ID 4 from the server 2, the processing unit 12 stores the authentication information 3 and the session ID 4 in the storage unit 11.

After that, when receiving a processing request 5 including the authentication information from the user apparatus 1, the processing unit 12 accesses the storage unit 11 to check the authentication information included in the processing request 5 against the authentication information 3 stored in the storage unit 11. This check is Basic authentication, for example. If the check results in finding a match between the two pieces of authentication information, the processing unit 12 includes a corresponding session ID in an acquisition request 6 for data 7, which is to be used in processing in accordance with the processing request 5, and sends the acquisition request 6 to the server 2. The server 2 then returns the data 7 in response to the acquisition request 6. The processing unit 12 receives the returned data 7, and then performs the processing using the received data 7 in accordance with the processing request 5. The processing unit 12 sends the processing result 8 to the user apparatus 1.

In the above-described system, when a user operating the user apparatus 1 logs in to the server 2 via the information processing apparatus 10, the information processing apparatus 10 stores the authentication information 3 and the session ID 4. After that, for example, when the user apparatus 1 needs data held in the server 2 for use in processing during execution of software and sends the processing request 5 including the authentication information, the information processing apparatus 10 performs Basic authentication. After the authentication is successful, the information processing apparatus 10 sends the acquisition request 6 including the session ID 4 to the server 2, and the server 2 returns the data 7. The information processing apparatus 10 performs processing using the data 7 in accordance with the processing request 5, and sends the processing result 8 to the user apparatus 1. The user apparatus 1 continues to execute the software using the processing result 8.

As described above, in the first embodiment, when the user apparatus 1 needs data that is provided by the server 2 for use in processing during execution of software, the user apparatus 1 just sends the processing request 5 including authentication information to the information processing apparatus 10. That is, once the user completes a login procedure for the server 2, the user does not need to repeat the login procedure for the server 2. Therefore, there is no need to incorporate a program module that is dependent on the login authentication method of the server 2 in the software that is executed by the user apparatus 1, which makes it easy to develop the software. As a result, it is possible to improve the user friendliness of the service provided by the server 2.

In addition, in the first embodiment, the session ID generated by the server 2 is managed by the information processing apparatus 10. Therefore, the user apparatus 1 does not need to manage the session ID. This makes it much easier to develop the software that is used in the user apparatus 1.

In this connection, an expiration date may be set in the session ID 4. Such an expiration date is indicated in a session ID, for example. If the expiration date is set in the session ID 4, the processing unit 12 determines whether the expiration date of the session ID 4 is expired, on the basis of expiration information indicated in the session ID 4. If the expiration date is expired, the processing unit 12 retrieves the authentication information 3 from the storage unit 11, and sends a login request including the authentication information 3 to the server 2. In response to this login request, the server 2 performs a login process. If the login is successful, the server 2 returns a login completion response including a new session ID to the information processing apparatus 10. Upon receipt of the login completion response, the processing unit 12 updates the session ID 4 to the new session ID included in the login completion response in the storage unit 11.

The above automated update of an expired session ID eliminates the need to repeat the login procedure. The user apparatus 1 may need to perform the login procedure for the server 2 just once even if the session ID 4 has an expiration date. This improves the user friendliness of the service provided by the server 2 for the user apparatus 1.

### Second Embodiment

The following describes a second embodiment. In the second embodiment, a service provided by a web server is used via a web API. In this case, a computer operated by a user uses the service provided by the web server, by executing an API use application.

In many cases, web servers perform forms authentication. When a user wants to use a service provided by a web server via a web browser, the web server requests the user to do user authentication on a login screen that is unique to the web server. By providing the user with a login screen specific to the user-desired service, the server is able to enforce the uniqueness of the service. Therefore, it may not be desirable to modify a web application that runs on the web server.

On the other hand, in the case where a service provided by a web server employing forms authentication is used via an API server, an API authentication method is dependent strongly on a login screen, and this is not user friendly. For example, under the situation where the web server performs its unique forms authentication, a program module configured for the unique forms authentication needs to be incorporated in the API use application that runs on the computer operated by the user. This increases the load of developing the API use application. In addition, in the forms authentication, whether a user is a logged-in user or not is managed using a session ID, and therefore, a program module for managing the session ID needs to be incorporated in the API use application as well. This also increases the load of developing the API use application.

To deal with this, the second embodiment is designed such that, if an API use application complies with a standard authentication method such as Basic authentication or Digest authentication, the API use application is able to use, via an API server, the service provided by the web server employing the forms authentication.

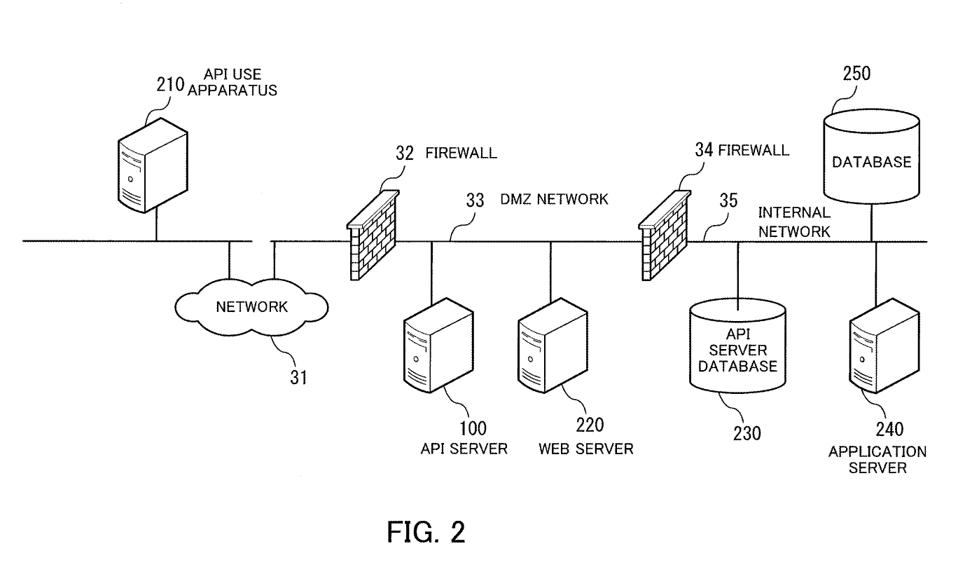

FIG. 2 illustrates an example of a configuration of a system according to the second embodiment. An API use apparatus 210 is connected to a service providing system via a network 31. In the service providing system, a DMZ network 33 is connected to the network 31 via a firewall 32. In addition, an internal network 35 is connected to the DMZ network 33 via a firewall 34. An API server 100 and a web server 220 are connected to the DMZ network 33. An API server database 230, an application server 240, and a database 250 are connected to the internal network 35.

The web server 220, application server 240, and database 250 form a web three-tier system, for example. The web server 220 cooperates with the application server 240 and database 250 to provide a service, such as data and functions, for the API use apparatus 210. The web server 220 implements a service providing function by executing, for example, web service providing application software (hereinafter, referred to as a web application).

In this connection, the web server 220 manages the accounts of users permitted to use the service. The account of each user includes the authentication information of the user. The web server 220 performs forms authentication using the user's authentication information, and if the authentication is successful, permits the user's login. After that, the web server 220 provides the service in response to requests from an apparatus operated by the logged-in user.

The API use apparatus 210 executes an application (API use application) that uses a web API. By executing the API use application, the API use apparatus 210 is able to receive the service provided by the web server 220 via the API server 100.

The API server 100 is a computer that provides processing using the web API. For example, the API server 100 causes the web server 220 to perform processing in accordance with a web API processing request from the API use apparatus 210. Then, the API server 100 receives the processing result from the web server 220, performs processing defined in the web API on the received processing result, and sends the resultant data to the API use apparatus 210. For example, the API server 100 obtains HTML screen data for the web application from the web server 220 with the HTTP GET method. The API server 100 parses the received HTML screen data to obtain desired data. Then, the API server 100 processes the obtained data into a data structure defined in the web API, and sends the resultant to the API use apparatus 210.

In this connection, the web server 220 provides the service for only apparatuses operated by users that have been authenticated as authorized users by the forms authentication. The API server 100 mediates the forms authentication between the API use apparatus 210 and the web server 220, and holds authentication information sent by the API use apparatus 210. After that, the API server 100 authenticates the user operating the API use apparatus 210, using the held authentication information with an authentication method different from the forms authentication.

For example, the API server 100 performs user authentication with such an authentication method that enables both user authentication and processing request simultaneously by using a processing request including authentication information for a desired service. Such authentication methods include Basic authentication and Digest authentication. If it is possible to include the authentication information in a processing request, there is no need for the API use apparatus to perform any processing for a login form used in the web server 220, which reduces the processing load on the API use apparatus 210. In addition, if it is possible to authenticate a user with Basic authentication or Digest authentication, there is no need for the API use apparatus 210 to create an HTML form unique to the application of the web server 220. This makes it easy to build an application for use on the API use apparatus 210. In the following description, it is assumed that the API server 100 uses the Basic authentication for the user authentication.

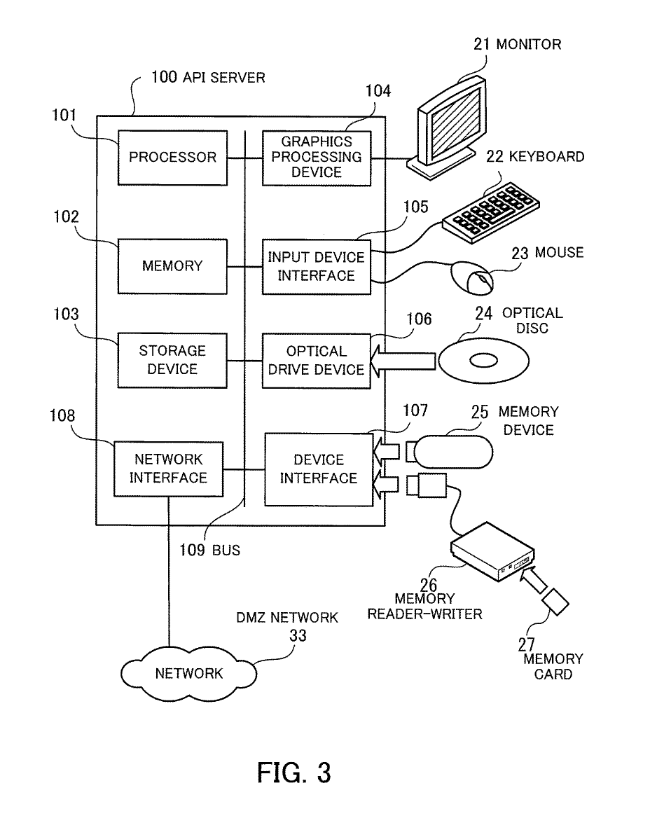

FIG. 3 illustrates an example of a hardware configuration of an API server that is used in the embodiment. The API server 100 is entirely controlled by a processor 101. A memory 102 and a plurality of peripherals are connected to the processor 101 with a bus 109. The processor 101 may be a multiprocessor. The processor 101 may be a Central Processing Unit (CPU), a Micro Processing Unit (MPU), or a Digital Signal Processor (DSP), for example. At least part of functions of the processor 101 may be implemented by using Application Specific Integrated Circuit (ASIC), Programmable Logic Device (PLD), or other electronic circuits.

The memory 102 is used as a primary storage device of the API server 100. The memory 102 temporarily stores therein at least part of Operating System (OS) programs and application programs that are executed by the processor 101. In addition, the memory 102 stores therein various data that is used by the processor 101 in processing. For example, as the memory 102, a Random Access Memory (RAM) or another volatile semiconductor storage device may be used.

The peripherals connected to the bus 109 include a storage device 103, a graphics processing device 104, an input device interface 105, an optical drive device 106, a device interface 107, and a network interface 108.

The storage device 103 electrically or magnetically writes and reads data to and from a built-in recording medium. The storage device 103 is used as an auxiliary storage device of the API server 100. The storage device 103 stores therein OS programs, application programs, and various data. In this connection, as the storage device 103, a Hard Disk Drive (HDD) or Solid State Drive (SSD) may be used, for example.

A monitor 21 is connected to the graphics processing device 104. The graphics processing device 104 displays images on the monitor 21 in accordance with instructions from the processor 101. As the monitor 21, a Cathode Ray Tube (CRT) display device, a liquid crystal display device, or another may be used.

A keyboard 22 and a mouse 23 are connected to the input device interface 105. The input device interface 105 gives signals received from the keyboard 22 and mouse 23 to the processor 101. In this connection, the mouse 23 is an example of pointing devices. Another pointing device may be used. Other pointing devices include touch panels, tablets, touch pads, track balls, and others.

The optical drive device 106 reads data from an optical disc 24 with laser light or others. The optical disc 24 is a portable recording medium on which data is recorded so as to be readable with reflection of light. As the optical disc 24, a Digital Versatile Disc (DVD), DVD-RAM, Compact Disc Read Only Memory (CD-ROM), CD-R (Recordable), CD-RW (ReWritable), or another may be used.

The device interface 107 is a communication interface for connecting peripherals to the API server 100. For example, a memory device 25 or a memory reader-writer 26 may be connected to the device interface 107. The memory device 25 is a recording medium that has a function of communicating with the device interface 107. The memory reader-writer 26 writes and reads data to and from a memory card 27 that is a card recording medium.

The network interface 108 is connected to the DMZ network 33. The network interface 108 communicates data with another computer or communication device over the DMZ network 33.

With the above hardware configuration, the processing functions of the second embodiment may be implemented. In this connection, the information processing apparatus 10 of the first embodiment may be implemented with the same hardware as the API server 100 illustrated in FIG. 3.

The API server 100 executes a program recorded on a computer-readable recording medium to implement the processing functions of the second embodiment, for example. The program describing the content of processing that is executed by the API server 100 may be recorded on various recording media. For example, a program that is executed by the API server 100 may be stored on the storage device 103. The processor 101 loads at least part of the program from the storage device 103 to the memory 102 and executes the program. In addition, the program that is executed by the API server 100 may be recorded on a portable recording medium, such as the optical disc 24, memory device 25, or memory card 27. For example, under the control of the processor 101, the program stored in the portable recording medium is installed on the storage device 103 so as to be executable. Alternatively, the processor 101 may read the program directly from the portable recording medium and execute the program.

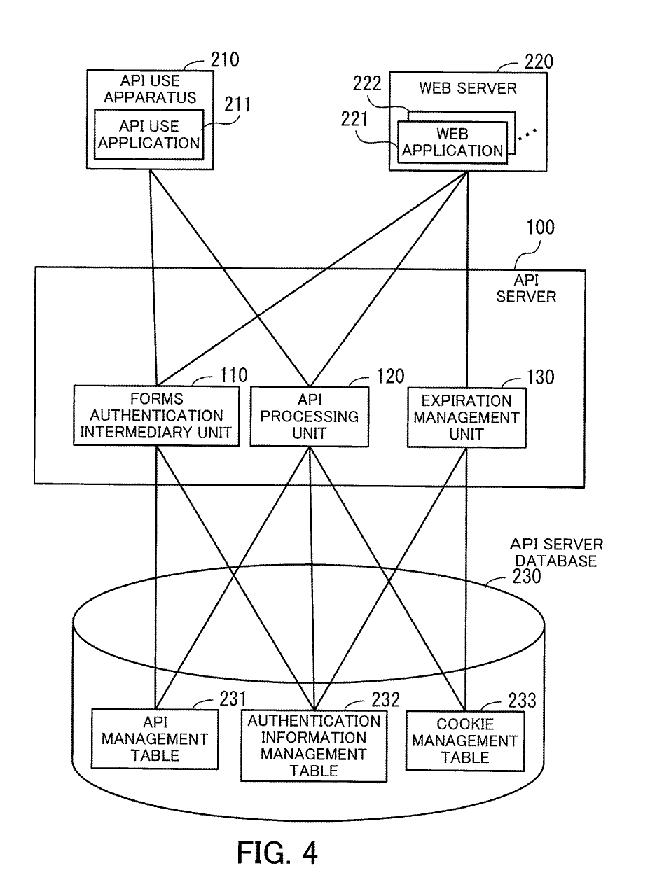

FIG. 4 is a block diagram illustrating functions of each apparatus. The API use apparatus 210 includes an API use application 211. The web server 220 includes a plurality of web applications 221, 222, . . . .

The API server 100 includes a forms authentication intermediary unit 110, an API processing unit 120, and an expiration management unit 130. The forms authentication intermediary unit 110 mediates forms authentication that is performed when a user operating the API use apparatus 210 logs in to the web server 220.

Upon receipt of a processing request for processing using a service provided by a web application from the API use apparatus 210, the API processing unit 120 authenticates the user operating the API use apparatus 210 with an authentication method different from the forms authentication. For example, the API processing unit 120 performs the user authentication with Basic authentication or Digest authentication. If the user is authenticated, the API processing unit 120 accesses the web server 220 to cause the web server 220 to execute the service using the web application specified by the processing request. Then, the API processing unit 120 receives the result from the web server 220, performs prescribed processing on the received result, and sends the resultant to the API use apparatus 210.

The expiration management unit 130 manages the expiration date of a cookie that is generated when the user of the API use apparatus 210 logs in to the web server 220.

The API server database 230 manages information that is used by the API server 100. For example, the API server database 230 includes an API management table 231, an authentication information management table 232, and a cookie management table 233. The API management table 231 is a data table for managing an API provided for each web application. The authentication information management table 232 is a data table for managing user authentication information. The cookie management table 233 is a data table for managing cookies that are issued at the time of login to the web server 220.

In this connection, lines connecting the units illustrated in FIG. 4 represent some of communication paths, and other communication paths than illustrated may be configured. In addition, the functions of each unit illustrated in FIG. 4 may be implemented by causing a computer to execute a program module corresponding to the unit.

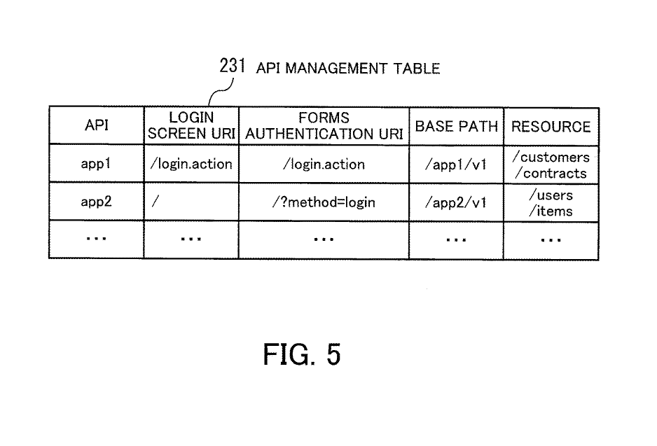

The following describes each data table in detail, with reference to FIGS. 5 to 7.

FIG. 5 illustrates an example of an API management table. The API management table 231 has the following columns: API, login screen Uniform Resource Identifier (URI), forms authentication URI, base path, and resource.

The API column contains the name of an API that provides a service using a web application. For example, the name of a web application used is set as the name of an API that provides a service using the web application.

The login screen URI column contains a URI indicating a location where login screen data for a corresponding web application is stored. Upon receipt of a user registration request from the API use apparatus 210, the forms authentication intermediary unit 110 sends a login screen request to the web server 220 on the basis of the URI set in the login screen URI column. For example, the user registration request includes information like “{application name}/{version}/login-forms”. The forms authentication intermediary unit 110 refers to the API management table 231 to obtain a login screen URI from a record corresponding to the “application name” included in the user registration request. The forms authentication intermediary unit 110 then sends a login screen request specifying the obtained login screen URI to the web server 220.

The forms authentication URI column contains a URI indicating a resource (for example, a program) used for performing the forms authentication for the corresponding web application. Upon receipt of a forms authentication request from the API use apparatus 210, the forms authentication intermediary unit 110 transfers the forms authentication request to the resource identified by the forms authentication URI. For example, the forms authentication request sent from the API use apparatus 210 includes information like “{application name}/{version}/login”. The forms authentication intermediary unit 110 refers to the API management table 231 to obtain a forms authentication URI from the record corresponding to the “application name” included in the forms authentication request. The forms authentication intermediary unit 110 then sends a forms authentication request specifying the obtained forms authentication URI to the web server 220.

The base path column contains information indicating the location of a corresponding web application in the web server 220. The resource column contains the identification information of a resource provided by the API. It is possible to uniquely identify a resource, whose identification information is set in the resource column, by using information appended after the base path. For example, specifying “/app1/v1/customers” leads to accessing an API “/customers” that uses the service of the web application “app1”.

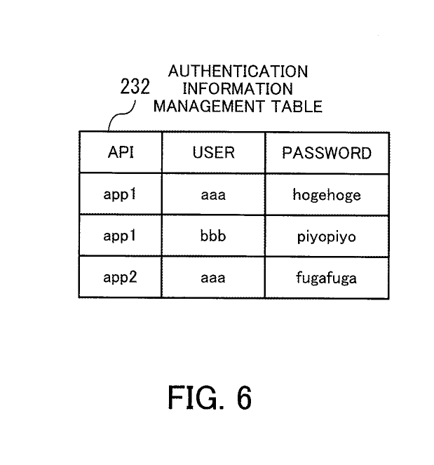

FIG. 6 illustrates an example of an authentication information management table. The authentication information management table 232 includes the following columns: API, user, and password. The API column contains the name of an API that provides a service using a web application. The user column contains the user name of a user that has logged in to a corresponding web application. The password column contains a password used in the user login. The password is hashed or encrypted according to the specifications of the web application, and then is stored in the authentication information management table 232.

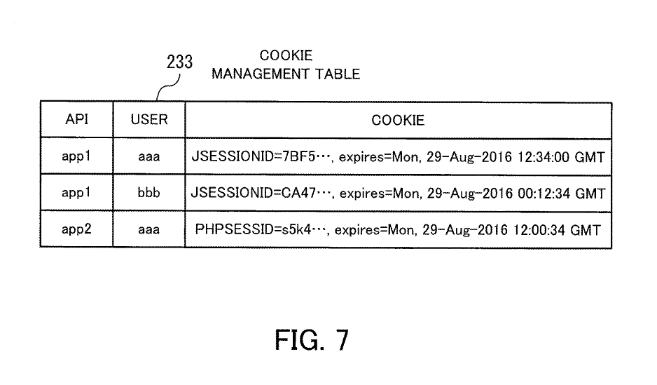

FIG. 7 illustrates an example of a cookie management table. The cookie management table 233 includes the following columns: API, user, and cookie. The API column contains the name of an API that provides a service using a web application. The user column contains the user name of a user that has logged in to a corresponding web application with the forms authentication. The cookie column contains a cookie issued by the web server 220 at the time of a user login. A cookie includes a session ID and information indicating the expiration date of a session. For example, the expiration date is specified by using “expires”, “max-age”, or another item included in the cookie.

The following describes how the API server performs an authentication process in detail.

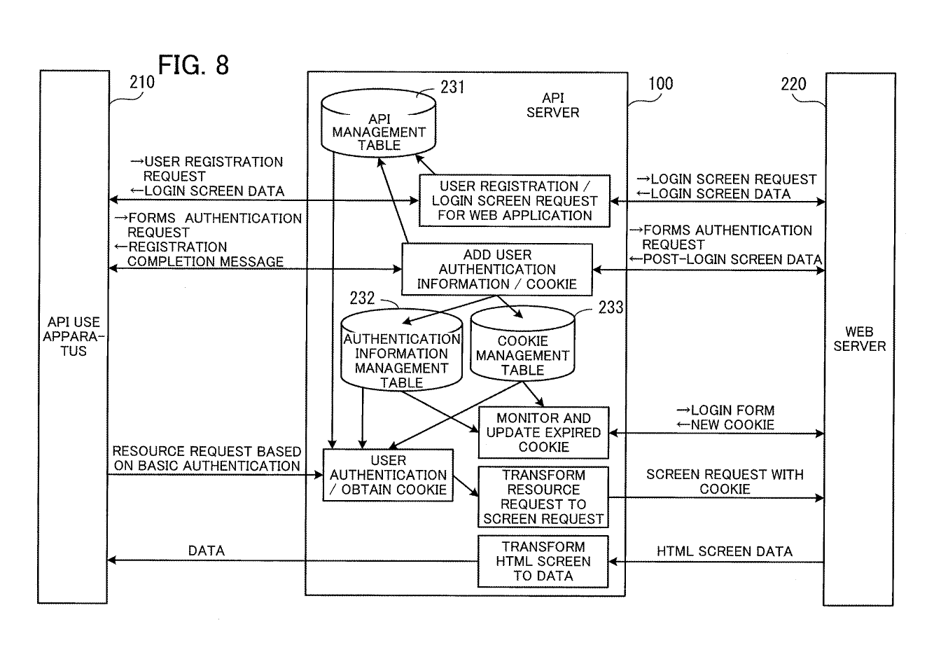

FIG. 8 illustrates an outline of an authentication process that is performed by an API server. Upon receipt of a user registration request for a specified web application from the API use apparatus 210, the API server 100 retrieves a login screen URI for the specified web application from the API management table 231. The API server 100 then sends a login screen request specifying the login screen URI to the web server 220.

In response to the login screen request, the web server 220 returns login screen data to the API server 100. The API server 100 sends the received login screen data to the API use apparatus 210, which then displays a login screen on a monitor of the API use apparatus 210. The user operating the API use apparatus 210 enters a user name and a password in corresponding fields on the login screen. Then, the API use apparatus 210 sends a forms authentication request including authentication information that is a combination of the user name and password to the API server 100.

Upon receipt of the forms authentication request, the API server 100 retrieves a forms authentication URI of the corresponding web application from the API management table 231. The API server 100 sends a forms authentication request specifying the retrieved forms authentication URI to the web server 220. The web server 220 performs the user authentication using the authentication information included in the forms authentication request. For example, the web server 220 determines whether the authentication information included in the forms authentication request matches any of the authentication information of previously-registered authorized users. If the authentication information matches any of the authentication information of the authorized users, the web server 220 permits the login for the user operating the API use apparatus 210, and sends post-login screen data, which is used after the login, to the API server 100. The post-login screen data includes a cookie.

The API server 100 that has received the post-login screen data stores the authentication information included in the forms authentication request in the authentication information management table 232. In addition, the API server 100 stores the cookie included in the post-login screen data in the cookie management table 233. Then, the API server 100 sends a registration completion message to the API use apparatus 210.

After that, when the API use apparatus 210 executes the API use application and starts to perform processing using a service provided by the web server 220, the API use apparatus 210 sends a resource request based on the Basic authentication to the API server 100. This resource request includes the authentication information used in the forms authentication. The API server 100 receives the resource request, and then performs the user authentication with the Basic authentication with reference to the authentication information management table 232. For example, the API server 100 determines whether a combination of the user name and password included as the authentication information in the resource request matches any combination of a user name and password registered in the authentication information management table 232. If there is a matching record, the API server 100 confirms that the resource request is from an authorized user corresponding to the user name of the record, and then retrieves the cookie of the user in question from the cookie management table 233. The API server 100 transforms the resource request into a screen request with the cookie included, and sends the screen request to the web server 220.

In response to the screen request, the web server 220 sends appropriate HTML screen data to the API server 100. The API server 100 transforms the received HTML screen data into data in prescribed data structure, and sends the obtained data to the API use apparatus 210. The API use apparatus 210 continues to execute the API use application using the data received from the API server 100.

In this connection, the API server 100 monitors whether there is any cookie whose expiration date is expired, with reference to the cookie management table 233. When the API server 100 detects a cookie whose expiration date is expired, the API server 100 retrieves the authentication information of the user corresponding to the cookie from the authentication information management table 232. The API server 100 then sends a forms authentication request including the retrieved authentication information to the web server 220. If the login is successful, a new cookie with a new expiration date is sent from the web server 220 to the API server 100. The API server 100 updates the cookie to the new cookie in the cookie management table 233. By doing so, cookies in the cookie management table 233 are occasionally updated to new cookies, whose expiration dates are not expired.

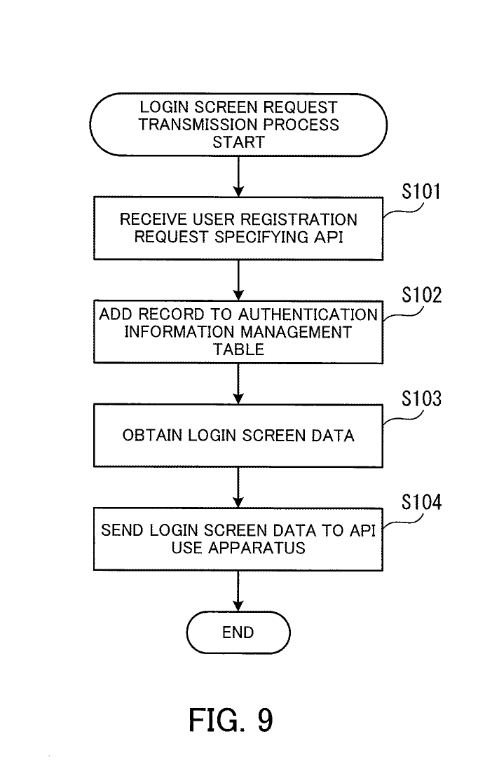

The following describes how the API server 100 operates in order to achieve the process of FIG. 8, with reference to FIGS. 9 to 12.

When the API use apparatus 210 starts to execute the API use application 211, the API use apparatus 210 sends a user registration request to the API server 100. Then, the API server 100 starts a login screen request transmission process.

FIG. 9 is a flowchart illustrating a login screen request transmission process. The process of FIG. 9 will be described step by step.

(Step S101) The forms authentication intermediary unit 110 receives a user registration request for registration of a user operating the API use apparatus 210, from the API use apparatus 210. The user registration request includes a user name, and the name of an API that provides a service using a web application.

(Step S102) The forms authentication intermediary unit 110 adds a record including a combination of the API name and user name to the authentication information management table 232.

(Step S103) The forms authentication intermediary unit 110 obtains login screen data for the web application corresponding to the specified API from the web server 220. For example, the forms authentication intermediary unit 110 obtains a login screen URI from a record of the API management table 231 corresponding to the API specified in the user registration request, and then sends a login screen request specifying the obtained login screen URI to the web server 220. The forms authentication intermediary unit 110 receives login screen data that has been sent from the web server 220 in response to the login screen request.

(Step S104) The forms authentication intermediary unit 110 sends the obtained login screen data as a response to the user registration request to the API use apparatus 210.

The API use apparatus 210 receives the login screen data and displays a login screen. When the user operating the API use apparatus 210 enters a user name and a password in corresponding fields on the login screen, the API use apparatus 210 sends a forms authentication request to the API server 100. Upon receipt of the forms authentication request, the API server 100 performs an authentication information and cookie addition process.

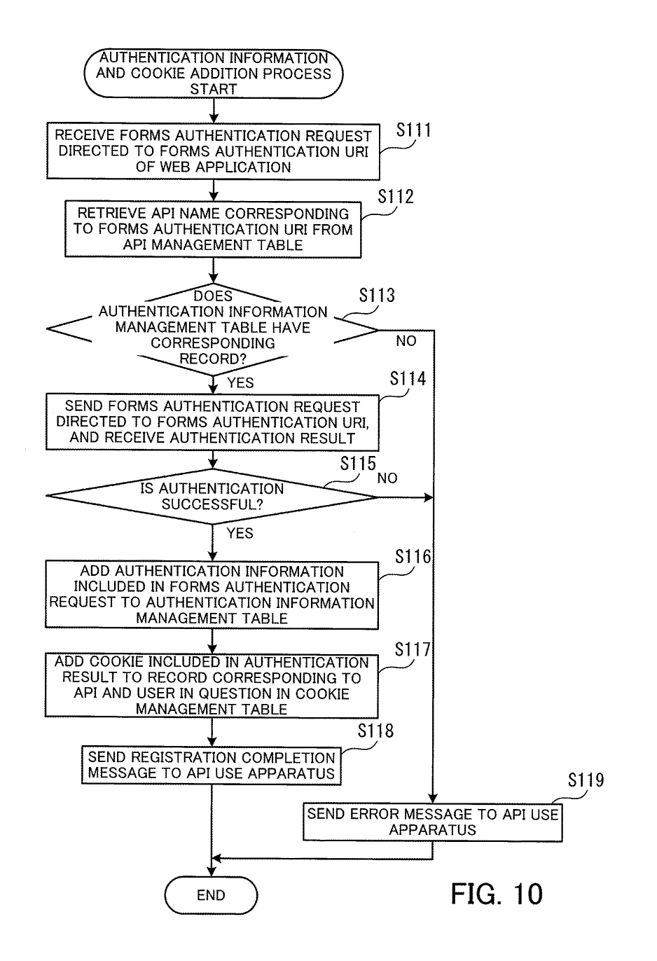

FIG. 10 is a flowchart illustrating the authentication information and cookie addition process. The process of FIG. 10 will be described step by step.

(Step S111) The forms authentication intermediary unit 110 receives a forms authentication request directed to a forms authentication URI of a web application from the API use apparatus 210. The forms authentication request includes a combination of the user name and password of a user operating the API use apparatus 210, as authentication information.

(Step S112) The forms authentication intermediary unit 110 retrieves an API name corresponding to the forms authentication URI indicated in the forms authentication request from the API management table 231.

(Step S113) The forms authentication intermediary unit 110 determines whether the authentication information management table 232 has a record corresponding to a combination of the user name indicated in the forms authentication request and the API name retrieved from the API management table 231. If such a record is found, the process proceeds to step S114. If no such a record is found, the process proceeds to step S119.

(Step S114) The forms authentication intermediary unit 110 sends a forms authentication request directed to the forms authentication URI. The forms authentication request is received by the web server 220, which then performs user authentication using the web application corresponding to the forms authentication URI. Then, the web server 220 sends an authentication result to the API server 100. The forms authentication intermediary unit 110 receives the authentication result. The authentication result includes a cookie. The cookie indicates a session ID and an expiration date.

(Step S115) The forms authentication intermediary unit 110 determines whether the authentication is successful. If the authentication is successful, the process proceeds to step S116. If the authentication has failed, then the process proceeds to step S119.

(Step S116) The forms authentication intermediary unit 110 adds the authentication information included in the forms authentication request to the record corresponding to the combination of the user name indicated in the forms authentication request and the API name retrieved from the API management table 231 in the authentication information management table 232.

(Step S117) The forms authentication intermediary unit 110 adds the cookie included in the authentication result to the record corresponding to the combination of the user name indicated in the forms authentication request and the API name retrieved from the API management table 231 in the cookie management table 233.

(Step S118) The forms authentication intermediary unit 110 sends a registration completion message to the API use apparatus 210. Then, the authentication information and cookie addition process is completed.

(Step S119) The forms authentication intermediary unit 110 sends an error message to the API use apparatus 210. Then, the authentication information and cookie addition process is completed.

Upon receipt of the registration completion message, the API use apparatus 210 continues the execution of the API use application 211. Then, when the API use apparatus 210 starts processing using a web API provided by the API server 100, the API use apparatus 210 sends a resource request based on the Basic authentication to the API server 100. Then, the API server 100 executes a user authentication and cookie acquisition process.

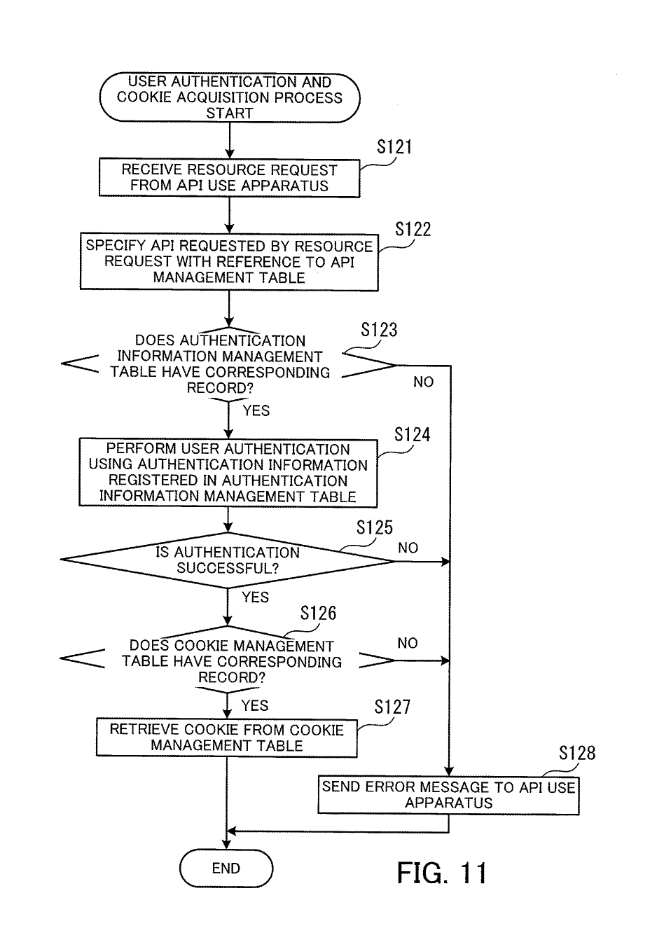

FIG. 11 is a flowchart illustrating the user authentication and cookie acquisition process. The process of FIG. 11 will be described step by step.

(Step S121) The API processing unit 120 receives a resource request based on the Basic authentication from the API use apparatus 210. The resource request includes authentication information for the Basic authentication and a resource for an API to be called.

(Step S122) The API processing unit 120 specifies an API requested by the resource request with reference to the API management table 231. For example, the API processing unit 120 searches the API management table 231 to find a record in which the resource specified in the base path and resource columns matches the resource indicated in the resource request. Then, the API processing unit 120 specifies the resource indicated in the found record as the API requested by the resource request.

(Step S123) The API processing unit 120 determines whether the authentication information management table 232 has a record corresponding to the combination of the API name of the specified API and the user name indicated in the authentication information included in the resource request. If such a record is found, the process proceeds to step S124. If no such a record is found, the process proceeds to step S128.

(Step S124) The API processing unit 120 performs the user authentication with a previously-specified authentication method using the authentication information (user name and password) registered in the authentication information management table 232. For example, the API processing unit 120 obtains a record corresponding to the combination of the API name of the specified API and the user name indicated in the authentication information included in the resource request from the authentication information management table 232. The API processing unit 120 then checks the combination of user name and password indicated in the obtained record against the combination of user name and password included in the resource request. If these combinations match, the API processing unit 120 authenticates that the user of the API use apparatus 210 having sent the resource request is an authorized user.

(Step S125) The API processing unit 120 determines whether the authentication is successful. If the authentication is successful, the process proceeds to step S126. If the authentication has failed, the process proceeds to step S128.

(Step S126) The API processing unit 120 determines whether the cookie management table 233 has a record corresponding to the combination of the API name of the specified API and the user name indicated in the authentication information included in the resource request. If such a record is found, the process proceeds to step S127. If no such a record is found, the process proceeds to step S128.

(Step S127) The API processing unit 120 retrieves a cookie corresponding to the combination of the API name of the specified API and the user name indicated in the authentication information included in the resource request from the cookie management table 233. Then, the user authentication and cookie acquisition process is completed.

(Step S128) The API processing unit 120 sends an error message to the API use apparatus 210. Then, the user authentication and cookie acquisition process is completed.

In the way as described above, a cookie for a user who has been authenticated successfully is obtained. It is possible to obtain HTML screen data from the web server using the obtained cookie.

In this connection, an expiration date is set in a cookie. If the expiration date of the cookie is expired, an error is returned in response to a screen request including the cookie sent to the web server 220. To avoid this, the expiration management unit 130 checks the expiration date of the cookie, and if the expiration date is expired, the expiration management unit 130 obtains a new cookie for the user corresponding to the expired cookie.

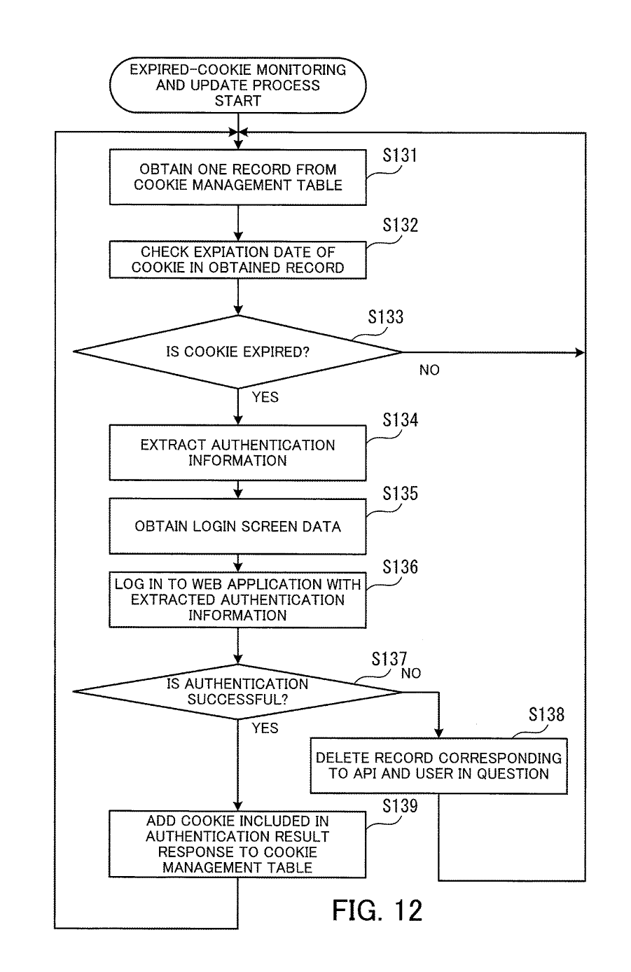

FIG. 12 is a flowchart illustrating an expired-cookie monitoring and update process. The process of FIG. 12 will be described step by step.

(Step S131) The expiration management unit 130 obtains one record from the cookie management table 233. For example, the expiration management unit 130 obtains a record from the cookie management table 233 in order from the top.

(Step S132) The expiration management unit 130 checks the expiration date of the cookie included in the obtained record.

(Step S133) The expiration management unit 130 determines whether the expiration date of the cookie included in the obtained record is expired. For example, the expiration management unit 130 determines that the expiration date is expired if the date and time indicated as the expiration date in the cookie is prior to the current date and time. If the expiration date is expired, the process proceeds to step S134. If the expiration date is not expired, the process proceeds to step S131.

(Step S134) The expiration management unit 130 extracts authentication information (user name and password) from the obtained record.

(Step S135) The expiration management unit 130 obtains login screen data for a web application corresponding to the expired cookie from the web server 220. For example, the expiration management unit 130 retrieves a login screen URI corresponding to the API indicated in the obtained record, from the API management table 231. Then, the expiration management unit 130 sends a login screen request directed to the retrieved login screen URI. By so doing, login screen data is returned from the web server 220.

(Step S136) The expiration management unit 130 performs a login process for a login to the web application corresponding to the expired cookie, using the authentication information extracted at step S134. For example, the expiration management unit 130 retrieves a forms authentication URI corresponding to the API indicated in the obtained record, from the API management table 231. Then, the expiration management unit 130 sends a forms authentication request that includes the authentication information extracted at step S134 and that is directed to the retrieved forms authentication URI. The web server 220 performs the user authentication process for the web application corresponding to the specified URI. Then, the web server 220 sends an authentication result response indicating the result of the user authentication to the API server 100.

(Step S137) The expiration management unit 130 determines whether the authentication is successful. For example, if the expiration management unit 130 receives post-login screen data including a new cookie as the authentication result response, the expiration management unit 130 determines that the authentication is successful. If the authentication is successful, the process proceeds to step S139. If the authentication has failed, the process proceeds to step S138.

(Step S138) The expiration management unit 130 deletes a record corresponding to the combination of API name and user name for which the authentication has failed, from both the authentication information management table 232 and the cookie management table 233. Then, the process proceeds to step S131.

(Step S139) The expiration management unit 130 adds the cookie included in the authentication result response to the record corresponding to the combination of API name and user name for which the authentication is successful in the cookie management table 233. Then, the process proceeds to step S131.

In the way as described above, each time the expiration date of a cookie is expired, an automated login process for login to a corresponding web application is performed, and the cookie is updated accordingly.

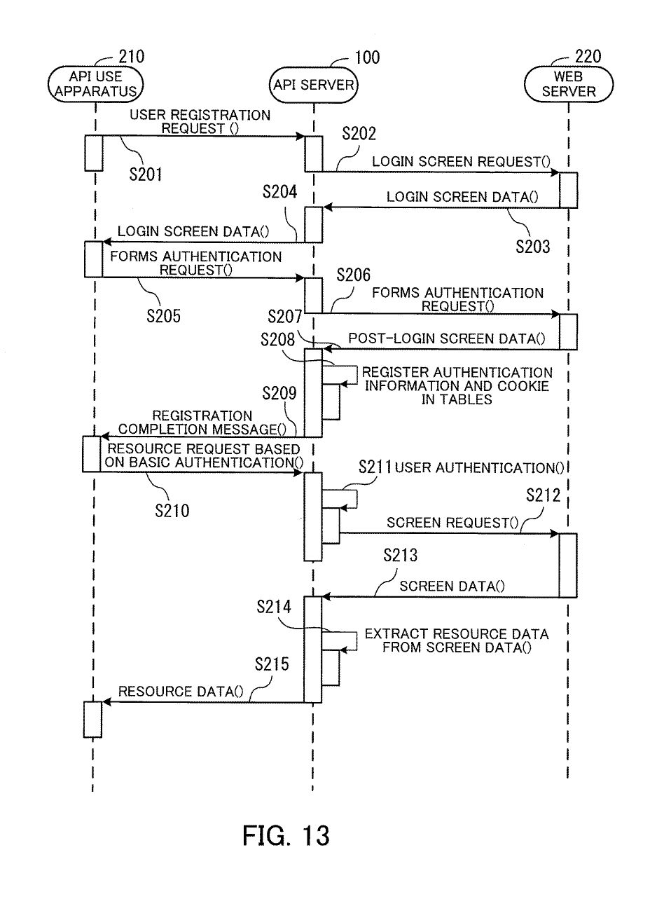

The following describes a specific example of data to be communicated between apparatuses, with reference to FIGS. 13 to 25.

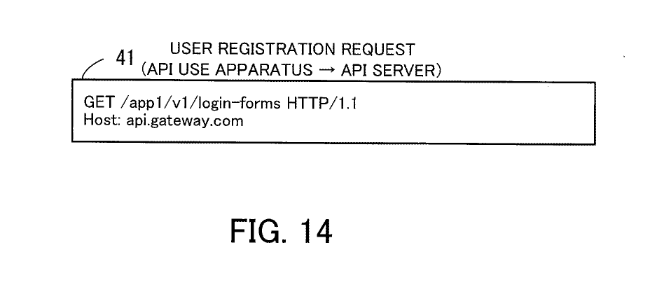

FIG. 13 is a sequence diagram illustrating how to provide a service for a user. The step numbers in the description made with reference to FIGS. 14 to 25 refer to steps of FIG. 13.

When the API use apparatus 210 operated by a user starts to execute the API use application 211, the API use apparatus 210 sends a user registration request to the API server 100 (Step S201).

FIG. 14 illustrates an example of a user registration request. The user registration request 41 includes a base path “/app1/v1” for a requested API, and information “/login-forms” indicating a resource for a process of obtaining a login form. Upon receipt of this user registration request 41, the API server 100 recognizes that this request is a request for obtaining a login form for an API “app1”, with reference to the API management table 231. Then, the API server 100 retrieves a login screen URI “/login.action” for the API “app1” from the API management table 231, and sends a login screen request to the web server 220 (step S202).

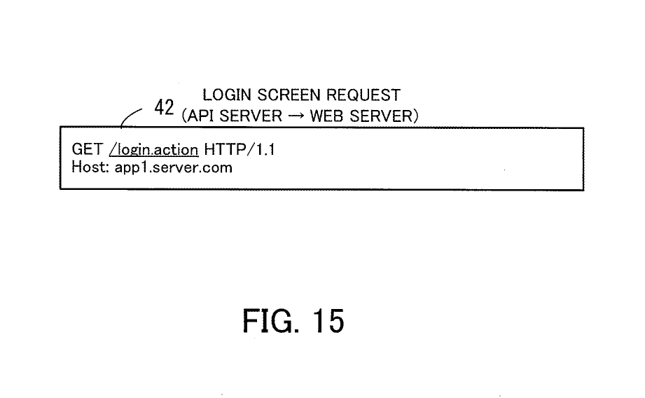

FIG. 15 illustrates an example of a login screen request. The login screen request 42 includes a forms authentication URI “/login.action” specifying a resource corresponding to a login function. The web server 220 having received the login screen request 42 obtains prepared login screen data using the resource corresponding to the forms authentication URI “/login.action”, and sends the login screen data to the API server 100 (step S203).

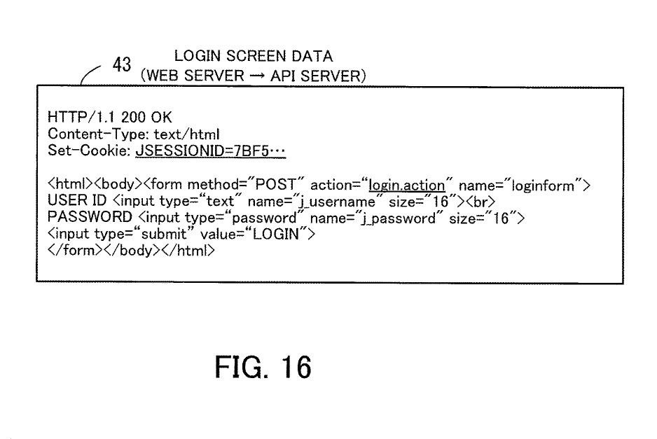

FIG. 16 illustrates an example of login screen data that is sent from the web server. The login screen data 43 that is sent from the web server 220 includes a cookie “JSESSIONID=7BF5 . . . ” In addition, the login screen data 43 indicates that the authentication information entered on a login screen is to be sent to a resource “/login.action”.

The API server 100 having received the login screen data 43 sends the login screen data with the transmission destination of the authentication information rewritten to a resource of the API server 100, to the API use apparatus 210 (step S204).

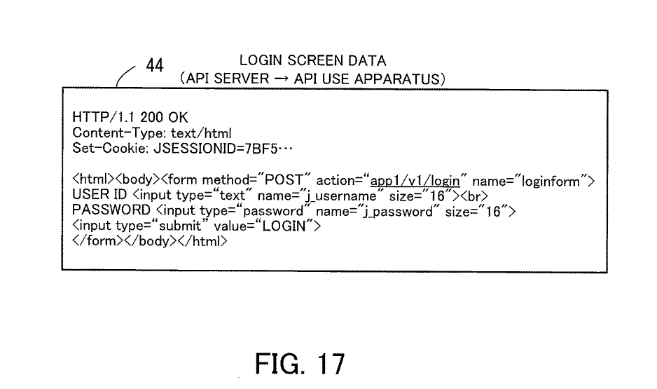

FIG. 17 illustrates an example of login screen data that is sent from the API server. The login screen data 44 that is sent from the API server includes a resource “app1/v1/login” of the API server 100 as the transmission destination of authentication information.

The API use apparatus 210 having received the login screen data 44 displays a login screen. Then, when the user enters a user name and a password as the authentication information, the API use apparatus 210 sends a forms authentication request including the entered authentication information to the API server 100 (step S205).

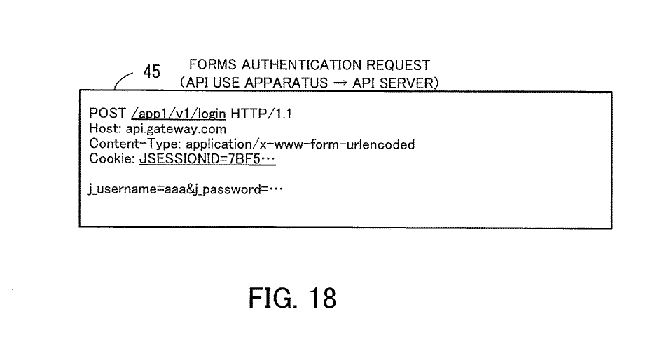

FIG. 18 illustrates an example of a forms authentication request that is sent from the API use apparatus. The forms authentication request 45 includes the cookie obtained from the login screen data 44 and the authentication information entered by the user. In addition, the transmission destination of the forms authentication request 45 is the resource “/app1/v1/login” of the API server 100.

The API server 100 having received the forms authentication request 45 changes the transmission destination of the forms authentication request 45 to a resource of the web server 220, and sends the changed forms authentication request to the web server 220 (Step S206).

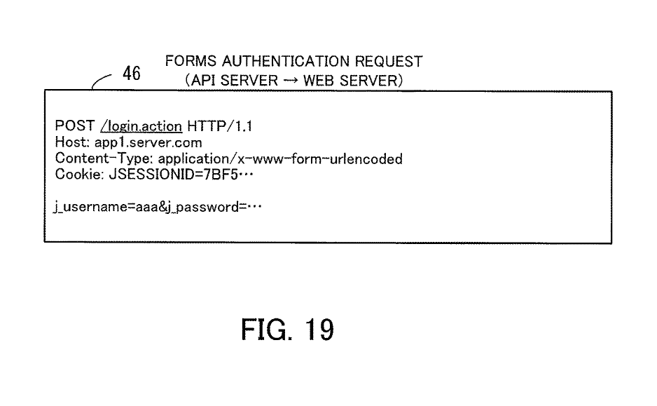

FIG. 19 illustrates an example of a forms authentication request that is sent from the API server. The forms authentication request 46 that is sent from the API server includes a transmission destination resource changed to “/login.action”. The web server 220 having received this forms authentication request 46 performs the user authentication on the basis of the authentication information included in the forms authentication request 46. In this example, it is assumed that the user authentication is successful. In this case, the web server 220 sends post-login screen data to the API server 100 (step S207).

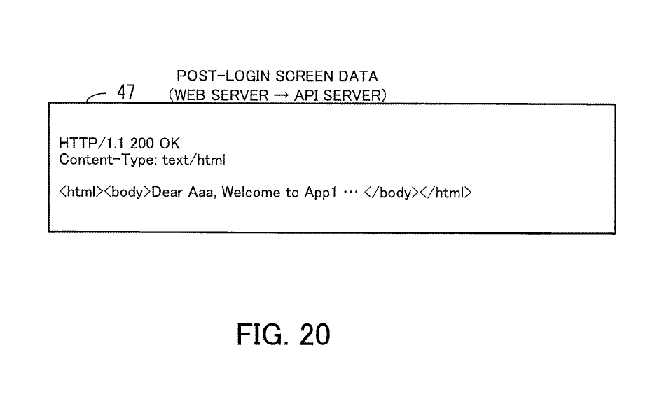

FIG. 20 illustrates an example of post-login screen data. The post-login screen data 47 includes a message indicating that a login is successful. The API server 100 having received the post-login screen data 47 stores the authentication information used in the login, in the authentication information management table 232, and stores the cookie obtained from the web server 220, in the cookie management table 233 (step S208). Then, the API server 100 sends a registration completion message to the API use apparatus 210 (step S209).

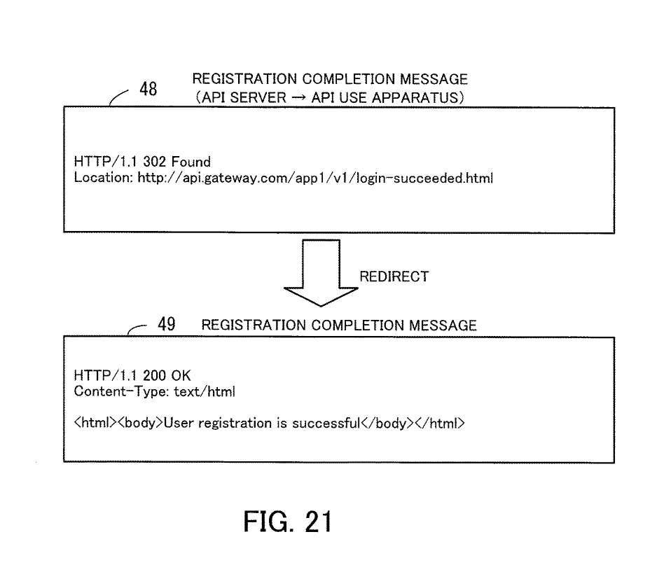

FIG. 21 illustrates an example of a registration completion message. For example, the registration completion message 48 specifies a redirect to a resource of the API server 100. This redirect enables the API use apparatus 210 to obtain another registration completion message 49 from the API server 100. The registration completion message 49 includes a message indicating that the user registration is complete.

After the user registration is complete, the API use apparatus 210 performs processing in the API use application 211. If the API use apparatus 210 needs to use, in the processing, data provided by any web application via a web API during execution of the API use application 211, the API use apparatus 210 sends a resource request based on the Basic authentication to the API server 100 (step S210).

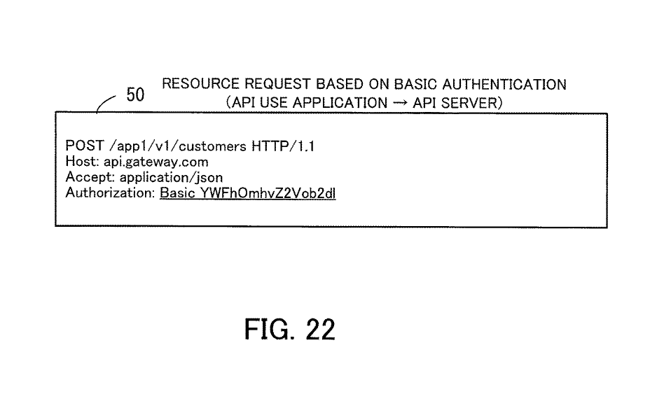

FIG. 22 illustrates an example of a resource request based on Basic authentication. The resource request 50 based on the Basic authentication includes authentication information used for the login based on the forms authentication. The authentication information used in the Basic authentication may have been encrypted.

The API server 100 having received the resource request 50 based on the Basic authentication performs user authentication with the Basic authentication method (step S211). If the authentication is successful, the API server 100 sends a screen request to the web server 220 (step S212).

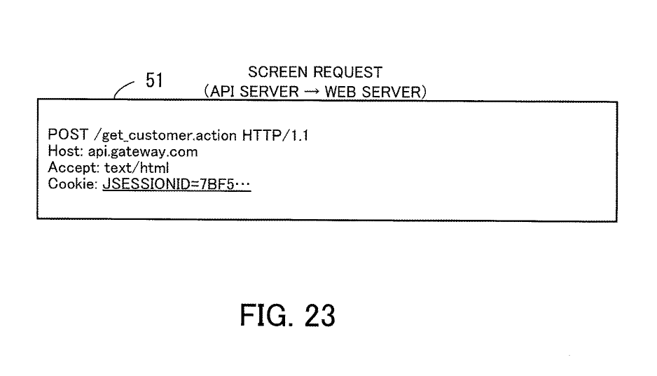

FIG. 23 illustrates an example of a screen request. The screen request 51 includes a cookie obtained at the time of a login with the forms authentication. The web server 220 having received the screen request 51 sends screen data representing a screen specified by the screen request 51 to the API server 100 (step S213).

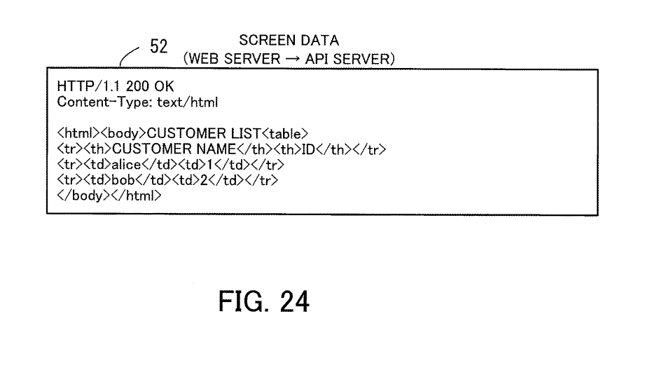

FIG. 24 illustrates an example of screen data. The screen data 52 includes information (customer list or the like) according to the content specified in the screen request 51. The API server 100 having received the screen data 52 extracts, from the screen data, resource data according to the request sent from the API use apparatus 210 (step S214). Then, the API server 100 sends the extracted resource data to the API use apparatus 210 (step S215).

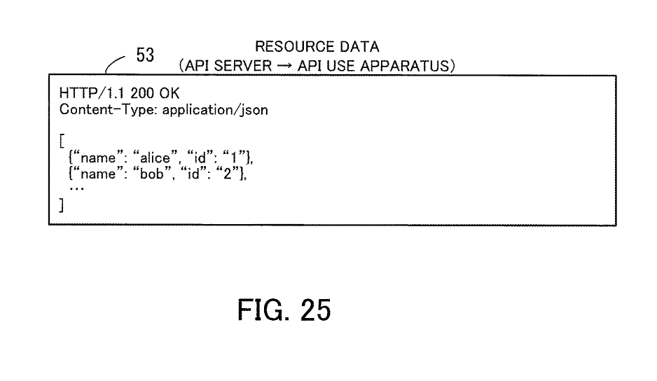

FIG. 25 illustrates an example of resource data. The resource data 53 includes data extracted from the screen data 52, for example. In addition, the resource data 53 has a different data structure from the screen data 52. The API use apparatus 210 having received the resource data 53 performs the processing using the resource data 53 in accordance with the API use application 211.

In the way as described above, the second embodiment enables the user operating the API use apparatus 210 to use a service provided by the web server 220 employing the forms authentication while having user authentication performed with the Basic authentication. As a result, there is no need to incorporate a program module for processing corresponding to each login screen unique to a web application 221, 222, in the API use application 211 installed in the API use apparatus 210, which reduces the load to develop the API use application 211. This results in an improvement in the user-friendliness of the service provided by the web server 220.

### Other Embodiments

While the second embodiment employs the Basic authentication as an authentication method executed by the API server 100, another authentication method, such as Digest authentication, may be employed. For example, other than the Basic authentication and Digest authentication, the API server 100 is able to employ such an authentication method that is able to perform user authentication by using a request including authentication information for a service other than login. That is to say, a request specifying a resource that performs user authentication needs to be sent to an apparatus that performs forms authentication, and it is not possible to cause the apparatus to perform the user authentication by sending a request including authentication information for processing other than the user authentication. In view of this, by using an authentication method that is able to perform user authentication in response to a request including authentication information for a desired service, it is possible to improve the user-friendliness of the service.

According to one aspect, it is possible to improve the user-friendliness of a service provided by a server.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store therein first authentication information corresponding to an account of a user on a server, and a session identifier (ID) generated by the server when the user logs in with the account; and
a processor configured to perform a process including
checking, upon receipt of a processing request including second authentication information from a user apparatus operated by the user, the second authentication information against the first authentication information, and
including, when the second authentication information and the first authentication information match, the session ID in an acquisition request for data to be used in processing that is performed in accordance with the processing request, and sending the acquisition request to the server.

2. The information processing apparatus according to claim 1, wherein the process further includes
performing the processing in accordance with the processing request, using the data returned from the server after sending the acquisition request, and
sending a result of the processing to the user apparatus.

3. The information processing apparatus according to claim 1, wherein the process further includes
sending, upon receipt of a login request including the first authentication information from the user apparatus, the login request directed to a prescribed resource of the server, and
storing, upon receipt of the session ID from the server, the first authentication information and the session ID in the memory.

4. The information processing apparatus according to claim 1, wherein the process further includes
determining based on expiration information indicated in the session ID stored in the memory whether an expiration date of the session ID is expired,
retrieving, upon determining that the expiration date is expired, the first authentication information from the memory,
sending a re-login request including the first authentication information to the server, and
updating, upon receipt of a login completion response including a new session ID from the server, the session ID to the new session ID in the memory.

5. An information processing system comprising:
a sever configured to store therein first authentication information corresponding to an account of a user, to generate a session identifier (ID) when the user logs in with the first authentication information, and to provide data in response to an acquisition request including the session ID; and
an information processing apparatus configured to check, upon receipt of a processing request including second authentication information from a user apparatus operated by the user, the second authentication information against the first authentication information, to include, upon determining that the second authentication information and the first authentication information match, the session ID generated by the server when the user logs in with the account, in the acquisition request for the data to be used in processing that is performed in accordance with the processing request, and to send the acquisition request to the server.

6. A user authentication method comprising:
checking, by a processor, upon receipt of a processing request including second authentication information from a user apparatus operated by a user, the second authentication information against first authentication information corresponding to an account of the user on a server; and
including, by the processor, upon determining that the second authentication information and the first authentication information match, a session identifier (ID) generated by the server when the user logs in with the account, in an acquisition request for data to be used in processing that is performed in accordance with the processing request, and sending the acquisition request to the server.
